(19) United States
(12) Patent Application Publication
(10) Pub. No.: US 2025/0230932 A1
(43) Pub. Date: Jul. 17, 2025

(54) COMBUSTOR AND GAS TURBINE

(71) Applicant: MITSUBISHI HEAVY INDUSTRIES, LTD., Tokyo (JP)

(72) Inventors: Shinichi FUKUBA, Tokyo (JP); Zhi ZHANG, Tokyo (JP); Keisuke MIURA, Tokyo (JP); Tomo KAWAKAMI, Tokyo (JP); Kiyoshi FUJIMOTO, Tokyo (JP); Taku EGAWA, Tokyo (JP); Kenta TANIGUCHI, Tokyo (JP)

(21) Appl. No.: 18/850,895

(22) PCT Filed: Jan. 25, 2023
(86) PCT No.: PCT/JP2023/002252

§ 371 Date: Sep. 25, 2024

(30) Foreign Application Priority Data
Mar. 30, 2022 (JP) 2022-056200

(51) Int. Cl. F23R 3/28; F02C 7/22; F23R 3/36

(52) U.S. Cl. CPC F23R 3/286; F02C 7/22; F23R 3/36; F05D 2240/35

(57) ABSTRACT

This combustor comprises: a combustor plate that has a mixing tube which extends so as to penetrate the combustor plate upstream end face and downstream end face perpendicular to the combustor axis and into which air is introduced from the upstream end face side; a first fuel injection part that is capable of injecting a first fuel along the center axis of the mixing tube on the inner side of the mixing tube; and a second fuel injection part that is capable of injecting a second fuel within the mixing tube radially outward of the center axis of the mixing tube.

### TECHNICAL FIELD

The present disclosure relates to a combustor and a gas turbine.

This application claims priority to Japanese Patent Application No. 2022-56200, filed in Japan on Mar. 30, 2022, the contents of which are incorporated herein by reference.

### BACKGROUND ART

For example, PTL 1 discloses a cluster combustor that is an example of a combustor used in a gas turbine.

The cluster combustor has a plurality of mixing tubes that are arranged side by side and into which air is introduced, and a fuel nozzle that injects fuel from a tip thereof inserted into the mixing tubes. The fuel nozzle injects fuel along a central axis line of the mixing tube.

A mixed gas of air and fuel is jetted from the fuel nozzle to a downstream side while flowing through the mixing tube, in conjunction with the injection of the fuel. In this case, the mixed gas is ignited, so that a plurality of small flames are formed at outlets of the respective mixing tubes.

### CITATION LIST

### Patent Literature

[PTL 1] United States Patent Application, Publication No. 2013-0067926

### SUMMARY OF INVENTION

### Technical Problem

However, in the combustor as described above, in order to suppress flashback in which a flame propagates upstream near the wall surface inside the mixing tube, it is necessary to suppress an increase in fuel concentration near the inner wall surface of the mixing tube. This tendency is particularly noticeable in a case where a relatively more reactive fuel is used.

On the other hand, particularly in a case where a fuel that is relatively difficult to burn is used, when the fuel concentration on the inner wall surface is low, there is a risk of blow-out, and stable combustion may not be performed.

The present disclosure has been made to solve the above problems, and an object thereof is to provide a combustor and a gas turbine capable of avoiding blow-out while suppressing flashback.

### Solution to Problem

In order to solve the above problems, according to the present disclosure, there is provided a combustor including a combustor plate that has a mixing tube extending to penetrate an upstream end surface and a downstream end surface orthogonal to a combustor axis line and into which air is introduced from an upstream end surface side; a first fuel injection unit that is capable of injecting first fuel along a central axis line of the mixing tube from inside the mixing tube; and a second fuel injection unit that is capable of injecting second fuel into the mixing tube from a radial outer side of the central axis line of the mixing tube.

A gas turbine according to the present disclosure includes a compressor that generates air; the combustor that generates a combustion gas by burning a premixed gas generated by mixing fuel with the air compressed by the compressor; and a turbine driven by the combustion gas.

### Advantageous Effects of Invention

According to the combustor and the gas turbine of the present disclosure, it is possible to avoid blow-out while suppressing flashback.

### BRIEF DESCRIPTION OF DRAWINGS

FIG. 1 is a schematic view showing a schematic configuration of a gas turbine according to a first embodiment of the present disclosure.

FIG. 2 is a vertical sectional view showing a schematic configuration of a combustor according to the first embodiment of the present disclosure.

FIG. 3 is a vertical sectional view of a main part of a combustor plate of the combustor according to the first embodiment of the present disclosure.

FIG. 4 is a perspective view of the combustor plate of the combustor according to the first embodiment of the present disclosure, the combustor plate being in a mixing tube.

FIG. 5 is a vertical sectional view of a main part of a combustor plate of a combustor according to a second embodiment of the present disclosure.

FIG. 6 is a vertical sectional view of a main part of a combustor plate of a combustor according to a third embodiment of the present disclosure, and is a view in which a sectional shape of a strut is also described.

### DESCRIPTION OF EMBODIMENTS

### First Embodiment

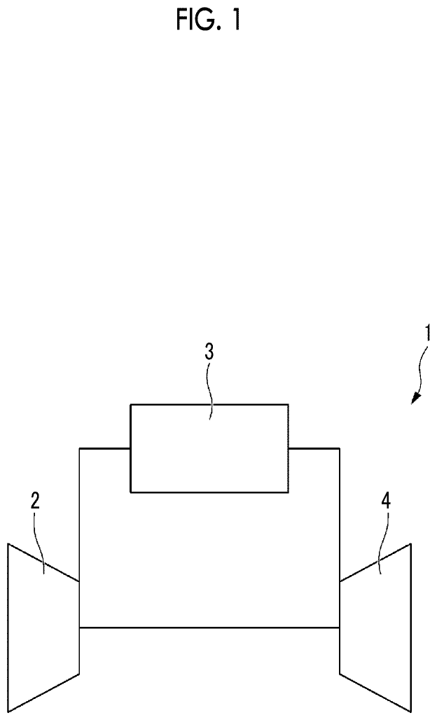

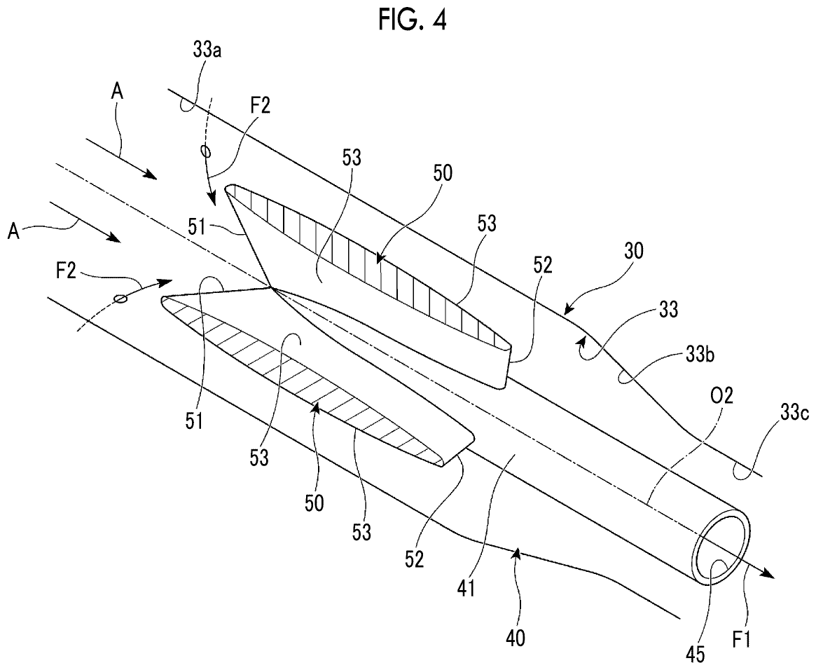

Hereinafter, a first embodiment of the present invention will be described in detail with reference to FIGS. 1 to 4. As shown in FIG. 1, a gas turbine 1 according to the present embodiment includes a compressor 2 that compresses air A, a combustor 3 that generates a combustion gas C, and a turbine 4 that is driven by the combustion gas C.

A plurality of combustors 3 are provided at intervals in a circumferential direction around a rotary shaft of the gas turbine 1. The combustor 3 mixes a fuel with the air A compressed by the compressor 2 to burn the mixture and generates the combustion gas C which has high temperature and high pressure.

### (Combustor)

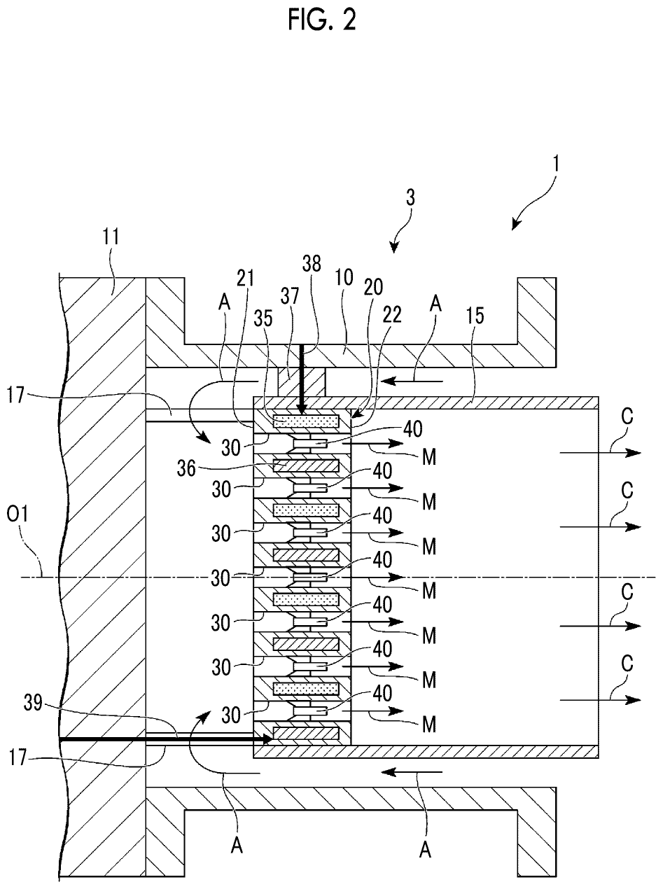

Hereinafter, the configuration of the combustor 3 will be described with reference to FIGS. 2 to 4.

The combustor 3 includes an outer cylinder 10, an end cover 11, an inner cylinder 15, a support portion 17, a combustor plate 20, a first fuel injection unit 40, and a second fuel injection unit 70.

### (Outer Cylinder)

The outer cylinder 10 has a cylindrical shape centered on a combustor axis line O1 (hereinafter, simply referred to as an axis line O1) that is a center of the combustor 3.

### (End Cover)

The end cover 11 has a disk shape that closes an end portion of the outer cylinder 10 on one side (left side in FIG. 2) in a direction of the axis line O1. The end portion of the outer cylinder 10 on one side in the direction of the axis line O1 is brought into contact with the end cover 11.

### (Inner Cylinder)

The inner cylinder 15 is disposed coaxially inside the outer cylinder 10. The inner cylinder 15 has a cylindrical shape extending in the direction of the axis line O1 inside the outer cylinder 10. An end portion of the inner cylinder 15 on one side in the direction of the axis line O1 is separated from the end cover 11 in the direction of the axis line O1. An outer diameter of the inner cylinder 15 is smaller than an inner diameter of the outer cylinder 10. Accordingly, an annular flow path is formed between an outer peripheral surface of the inner cylinder 15 and an inner peripheral surface of the outer cylinder 10. The air A compressed by the compressor 2 flows in the flow path from the other side (right side in FIG. 2) in the direction of the axis line O1 toward the one side in the direction of the axis line O1.

### (Support Portion)

The support portions 17 are members extending in the direction of the axis line O1, and a plurality of the support portions 17 are provided at intervals in the circumferential direction. An end portion of the support portion 17 on one side in the direction of the axis line O1 is fixed to a surface of an inner peripheral side of the outer cylinder 10, the surface facing the other side in the direction of the axis line O1 of the end cover 11. When the air A flowing between the outer cylinder 10 and the inner cylinder 15 to one side in the direction of the axis line O1 passes between the support portions 17 adjacent to each other, a flowing direction is inverted to the other side in the direction of the axis line O1.

### (Combustor Plate)

The combustor plate 20 has a disk shape centered on the axis line O1. The combustor plate 20 is provided to be fitted coaxially inside the inner cylinder 15. The combustor plate 20 has an upstream end surface 21 and a downstream end surface 22.

### (Upstream End Surface)

The upstream end surface 21 is an end surface of the combustor plate 20 facing one side in the direction of the axis line O1, and has a flat surface shape orthogonal to the axis line O1. The upstream end surface 21 is disposed at the same position in the direction of the axis line O1 as the end surface of the inner cylinder 15 on one side in the direction of the axis line O1.

### (Downstream End Surface)

The downstream end surface 22 is an end surface of the combustor plate 20 facing the other side in the direction of the axis line O1, and has a flat surface shape orthogonal to the axis line O1. The downstream end surface 22 is positioned on one side in the direction of the axis line O1 with respect to an end surface of the inner cylinder 15 on the other side in the direction of the axis line O1. In this manner, a space is partitioned to be formed by an inner peripheral surface of the inner cylinder 15 and the downstream end surface 22 of the combustor plate 20. The space is a combustion space of the combustor 3.

### (Mixing Tube)

The mixing tube 30 is a tube extending in the direction of the axis line O1, and the air A flows into the mixing tube 30 from the upstream side (one side in the direction of the axis line O1, the left side in FIG. 2). The mixing tube 30 of the present embodiment is formed as a hole portion extending in the direction of the axis line O1 so as to penetrate the upstream end surface 21 and the downstream end surface 22 of the combustor plate 20. The mixing tubes 30 extend linearly in the direction of the axis line O1, and a plurality of the mixing tubes 30 are arranged side by side at intervals in a direction orthogonal to the axis line O1. An opening on an upstream end surface 21 side of the mixing tube 30 is an inlet opening 31 on the upstream side into which the air A flows. An opening on a downstream end surface 22 side of the mixing tube 30 is an outlet opening 32 on the downstream side through which a premixed gas M of the air A and the fuel is jetted. A flow path cross section of the mixing tube 30 has a circular shape centered on a central axis line O2 of the mixing tube 30.

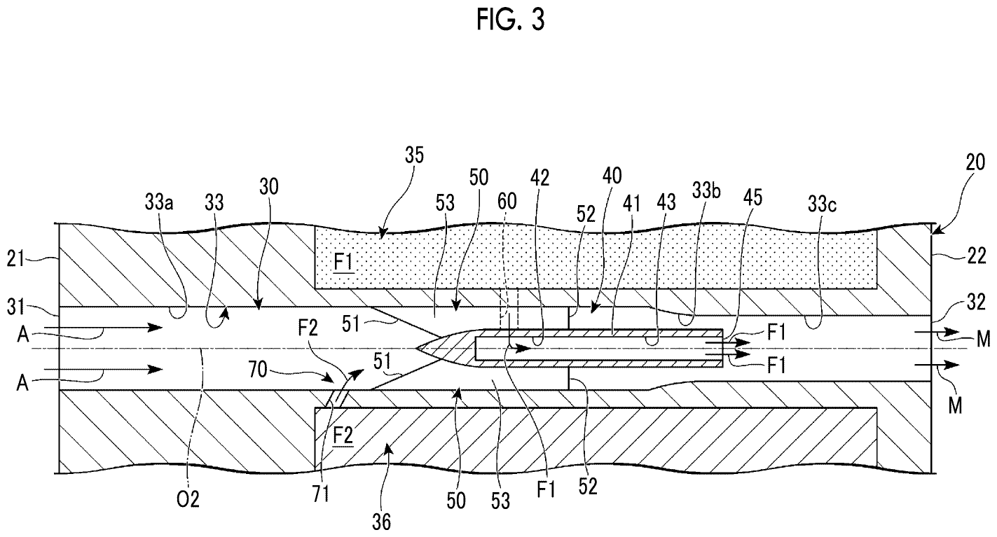

Specifically, as shown in FIG. 3, an inner wall surface 33 which is an inner peripheral surface of the mixing tube 30 includes three portions, that is, an upstream wall surface 33a, a reduced diameter wall surface 33b, and a downstream wall surface 33c.

The upstream wall surface 33a is a portion on the most upstream side of the inner wall surface 33 of the mixing tube 30. The sectional shape of the upstream wall surface 33a orthogonal to the axis line O1 has a circular shape at any position of the central axis line O2. The upstream wall surface 33a has a uniform inner diameter over the direction of the central axis line O2. An end portion of the upstream wall surface 33a on the upstream side is the above-described inlet opening 31.

The reduced diameter wall surface 33b is connected to the end portion of the upstream wall surface 33a on the downstream side. The reduced diameter wall surface 33b has a tapered shape that is gradually reduced in diameter toward the downstream side. The inner diameter of the end portion of the reduced diameter wall surface 33b on the upstream side is the same as the inner diameter of the end portion of the upstream wall surface 33a on the downstream side. Accordingly, the upstream wall surface 33a and the reduced diameter wall surface 33b are smoothly connected to each other without forming a step at a boundary therebetween. The reduced diameter wall surface 33b may have a conical surface shape or may have a convexly curved surface shape that is convex toward the inner wall surface 33 of the mixing tube 30. The sectional shape of the reduced diameter wall surface 33b orthogonal to the central axis line O2 is circular shape at any position of the central axis line O2.

The downstream wall surface 33c is connected to the end portion of the reduced diameter wall surface 33b on the downstream side. The sectional shape of the downstream wall surface 33c orthogonal to the axis line O1 has a circular shape at any position of the central axis line O2. The inner diameter of the end portion of the downstream wall surface 33c on the upstream side is the same as the inner diameter of the end portion of the reduced diameter wall surface 33b on the downstream side. Accordingly, the reduced diameter wall surface 33b and the downstream wall surface 33c are smoothly connected to each other without forming a step at a boundary therebetween. The downstream wall surface 33c has a uniform inner diameter over the direction of the central axis line O2. The inner diameter of the downstream wall surface 33c is one size smaller than the inner diameter of the upstream wall surface 33a. The end portion of the downstream wall surface 33c on the downstream side is the above-described outlet opening 32.

### (First Plenum and Second Plenum)

As shown in FIGS. 2 and 3, a first plenum 35 and a second plenum 36, which are spaces formed to avoid the mixing tube 30, are formed inside the combustor plate 20. The first plenum 35 and the second plenum 36 are isolated from the flow path in the mixing tube 30 via walls forming the inner wall surface 33 of the mixing tube 30. The first plenum 35 and the second plenum 36 are in a state of being not in communication with each other. That is, the first plenum 35 and the second plenum 36 are partitioned to be formed independently of each other in the combustor plate 20 so as not to interfere with each other.

For example, a first fuel F1 is supplied into the first plenum 35 via a first fuel supply system 38 passed through a connection member 37 connecting the outer cylinder 10 and the inner cylinder 15. Accordingly, the space in the first plenum 35 is filled with the first fuel F1.

For example, a second fuel F2 is supplied into the second plenum 36 via a second fuel supply system 39 passed through the support portion 17. Accordingly, the space in the second plenum 36 is filled with the second fuel F2.

The first fuel supply system 38 may be passed through the support portion 17, or the second fuel supply system 39 may be passed through the connection member 37. In addition, the first fuel supply system 38 and the second fuel supply system 39 may be provided at any location.

Here, in the present embodiment, the first fuel F1 is more reactive than the second fuel F2. That is, the first fuel F1 has higher reactivity than the second fuel F2. For example, hydrogen is used as the first fuel F1. For example, natural gas is used as the second fuel F2. Hydrogen is a more reactive fuel than natural gas.

### (First Fuel Injection Unit)

The first fuel injection unit 40 injects the first fuel F1 into the mixing tube 30 along the central axis line O2 of the mixing tube 30. The first fuel injection unit 40 includes a fuel nozzle 41, a strut 50, and a fuel introduction portion 60.

The fuel nozzle 41 is a member that is disposed in the mixing tube 30 and has a long shape extending in the direction of the central axis line O2 of the mixing tube 30. The fuel nozzle 41 is coaxial with the inner wall surface 33 of the mixing tube 30 and is provided at an interval from the inner wall surface 33 in a radial direction of the mixing tube 30.

The fuel nozzle 41 has a bottomed cylindrical shape in which an upstream side is closed and a downstream side is open. An end portion of the fuel nozzle 41 on the upstream side has a tapered shape in which a diameter is reduced toward the upstream side. That is, the end portion of the fuel nozzle 41 on the upstream side has a tapering shape toward the upstream side. An outer peripheral surface of the fuel nozzle 41, which is connected to the downstream side from the end portion of the fuel nozzle 41 on the upstream side, has a cylindrical surface shape centered on the central axis line O2 over the direction of the central axis line O2. The outer peripheral surface of the fuel nozzle 41 may have a tapered shape whose diameter is reduced toward the downstream side, that is, a tapering shape whose diameter is reduced toward the downstream side.

In the present embodiment, the end portion of the fuel nozzle 41 on the upstream side is positioned at the forming location of the upstream wall surface 33a on the inner wall surface 33 of the mixing tube 30. The end portion of the fuel nozzle 41 on the downstream side is positioned at a boundary between the reduced diameter wall surface 33b and the downstream wall surface 33c on the inner wall surface 33 of the mixing tube 30.

The sectional shape of the fuel nozzle 41 orthogonal to the central axis line O2 has a circular shape centered on the central axis line O2 at any position in the direction of the central axis line O2. Accordingly, an annular flow path centered on the central axis line O2 is formed between the fuel nozzle 41 and the inner wall surface 33.

A portion on the upstream side in the space inside the fuel nozzle 41 is a cavity 42 that is open to the inside of the mixing tube 30 at the end portion of the fuel nozzle 41 on the downstream side. An opening of the cavity 42 is a tip opening 45 of the fuel nozzle 41. The tip opening 45 has a circular shape centered on the central axis line O2.

### (Strut)

A plurality of struts 50 are provided at intervals in the circumferential direction in a flow path between the inner wall surface 33 of the mixing tube 30 and the fuel nozzle 41. The strut 50 has a role of holding the fuel nozzle 41 in the mixing tube 30. An end portion of the strut 50 on a radial outer side of the central axis line O2 is connected to the inner wall surface 33 of the mixing tube 30, and an end portion of the strut 50 on a radial inner side of the central axis line O2 is connected to the fuel nozzle 41.

The sectional shape of the strut 50 orthogonal to the central axis line O2 in the radial direction has a wing shape. That is, the strut 50 has a shape in which a wing shape is extended in a radial direction of the central axis line O2. In other words, the strut 50 has a wing shape in which the radial direction of the central axis line O2 is a wing height direction.

The end portion of the strut 50 on the upstream side is a leading edge 51 extending in the radial direction. The leading edge 51 extends to the radial inner side of the central axis line O2 toward the downstream side. Accordingly, an end portion of the leading edge 51 on the upstream side is connected to the inner wall surface 33 of the mixing tube 30, and an end portion of the leading edge 51 on the downstream side is connected to the fuel nozzle 41.

The end portion of the strut 50 on the downstream side is a trailing edge 52 extending in the radial direction. The trailing edge 52 extends to coincide with the central axis line O2 in the radial direction.

The wing shape of the strut 50 in a cross section orthogonal to the central axis line O2 in the radial direction is a shape that is larger toward the radial outer side in accordance with the shape of the leading edge 51. The strut 50 has a shape in which wing shapes that are gradually reduced from the radial outer side toward the radial inner side of the central axis line O2 are overlapped.

A pair of surfaces of the strut 50 facing the circumferential direction of the central axis line O2 connecting the leading edge 51 and the trailing edge 52 are wing surfaces 53. The pair of wing surfaces 53 are in contact with each other at the leading edge 51, are gradually separated from each other in the circumferential direction of the central axis line O2 toward the downstream side, and are connected to each other at the trailing edge 52 while becoming gradually close to each other in the circumferential direction of the central axis line O2 toward the downstream side.

In the present embodiment, the struts 50 are provided at equal intervals in the circumferential direction.

### (Fuel Introduction Portion)

The fuel introduction portion 60 introduces the first fuel F1 into the fuel nozzle 41. The fuel introduction portion 60 passes through the inside of the struts 50 and a wall portion that separates the inner wall surface 33 of the mixing tube 30 of the combustor plate 20 and the cavity 42 from each other, and connects the first plenum 35 with the cavity 42 in the mixing tube 30. The fuel introduction portion 60 is a hole portion extending in the radial direction of the central axis line O2 of the mixing tube 30, and an end portion on the radial outer side of the central axis line O2 is connected to the first plenum 35, and an end portion on the radial inner side of the central axis line O2 is connected to the cavity 42. A plurality of the fuel introduction portions 60 may be provided corresponding to the plurality of struts 50, or the fuel introduction portion 60 may be provided only in some of the struts 50 among the plurality of struts 50.

### (Second Fuel Injection Unit)

The second fuel injection unit 70 supplies the second fuel F2 into the mixing tube 30 at a location on the radial outer side with respect to the central axis line O2 of the mixing tube 30.

The second fuel injection unit 70 of the present embodiment has a wall surface hole 71 capable of injecting the second fuel F2 into the mixing tube 30 from the inner wall surface 33 of the mixing tube 30. The wall surface hole 71 is a hole portion extending linearly in the radial direction of the central axis line O2, and an end portion on the radial inner side of the central axis line O2 is open to the inner wall surface 33 of the mixing tube 30, while an end portion on the radial outer side of the central axis line O2 is open to the second plenum 36. Accordingly, the wall surface hole 71 allows the flow path in the mixing tube 30 and the second plenum 36 to communicate with each other.

The wall surface hole 71 extends toward the downstream side from the second plenum 36 toward a radial inner side. That is, the wall surface hole 71 is formed to be inclined from the radial direction of the mixing tube 30 and the central axis line O2. An inclination angle of the central axis line O2 of the wall surface hole 71 is set to, for example, 30° to 80°, preferably, 40° to 70°, and more preferably, 45° to 65°.

A plurality of the second fuel injection units 70 may be formed to be separated from each other in the circumferential direction of the central axis line O2, or only one of the second fuel injection units 70 may be formed.

The position of the second fuel injection unit 70 in the direction of the central axis line O2 is on the upstream side with respect to the first fuel injection unit 40. That is, the opening location of the second fuel injection unit 70 to the inner wall surface 33 of the mixing tube 30 is on the upstream side of the tip opening 45 of the fuel nozzle 41 of the first fuel injection unit 40.

In the present embodiment, the opening location of the second fuel injection unit 70 to the inner wall surface 33 of the mixing tube 30 is formed at a portion which is on the upstream wall surface 33a of the inner wall surface 33 of the mixing tube 30, the portion being further on the upstream side than the end portion of the strut 50 on the upstream side.

### (Operations and Effects)

Next, operations and operational effects of the combustor 3 according to the present embodiment will be described.

As shown in FIG. 3, during the operation of the gas turbine 1, the air A enters each of the mixing tubes 30 of the combustor plate 20 from the upstream side, and the air A flows in the mixing tube 30 toward the downstream side. In this state, when the first fuel F1 is injected into the mixing tube 30 by the first fuel injection unit 40 or the second fuel F2 is injected into the mixing tube 30 by the second fuel injection unit 70, the air A and the fuel are mixed in the mixing tube 30 to generate the premixed gas M. The premixed gas M is injected from the outlet opening 32 of the mixing tube 30 at the downstream end surface 22 of the combustor plate 20 and is ignited. As a result, the combustion gas C is generated by burning the premixed gas M, and the turbine 4 is rotationally driven by the combustion gas C being sent to the turbine 4.

Here, in the operation of the gas turbine 1, there is a case where only the first fuel F1, which is a relatively more reactive fuel, is charged into the combustor 3, and a case where only the second fuel F2, which is a relatively difficult to burn fuel, is charged into the combustor 3. That is, there is a case where the type of fuel is switched by the operation of the gas turbine 1.

In the present embodiment, the first fuel F1, which is a relatively more reactive fuel, is supplied into the mixing tube 30 via the first fuel injection unit 40. That is, the fuel introduced from a first fuel F1 plenum to the cavity 42 of the fuel nozzle 41 via the fuel introduction portion 60 is supplied into the mixing tube 30 via the tip opening 45. Since the tip opening 45 of the fuel nozzle 41 is disposed along the central axis line O2 of the mixing tube 30, the first fuel F1 jetted from the tip opening 45 flows in the mixing tube 30 along the central axis line O2.

Therefore, the first fuel F1 is prevented from diffusing to the radial outer side in the mixing tube 30, and the first fuel F1 is in a state of being gathered in a central portion of the mixing tube 30. That is, the fuel concentration distribution in the mixing tube 30 is high on the radial inner side and low on the radial outer side. Therefore, since the fuel concentration in the vicinity of the inner wall surface 33 of the mixing tube 30 can be suppressed, it is possible to avoid an occurrence of flashback in which a flame formed on the downstream end surface 22 propagates upstream near the inner wall surface 33 of the mixing tube 30. In particular, in a case where a type of fuel is reactive fuel, flashback is likely to occur. However, by injecting the first fuel F1 along the central axis line O2 as in the present embodiment, it is possible to appropriately avoid the occurrence of flashback even in such a case.

On the other hand, in a case where the second fuel F2, which is a relatively difficult to burn fuel, is charged, when the second fuel F2 is injected along the central axis line O2 of the mixing tube 30 in the same manner as the first fuel F1, the risk of blow-out increases. That is, in the outlet opening 32 of the mixing tube 30, an outer edge portion of the opening is a starting point of flame holding. Therefore, in a case where the fuel which is difficult to burn gathers at the center of the mixing tube 30, a region where the fuel concentration is high becomes a starting point of flame holding away from the fuel, and thus stable flame holding cannot be performed, and there is a possibility of blow-out.

In contrast, in the present embodiment, in a case where the second fuel F2, which is more difficult to burn, is charged, the second fuel F2 is not jetted along the central axis line O2 of the mixing tube 30 but is jetted from a location separated from the central axis line O2 toward the radial direction. That is, the second fuel F2 is injected into the mixing tube 30 from the inner wall surface 33 of the mixing tube 30 by the second fuel injection unit 70. Therefore, an extreme decrease in fuel concentration near the wall surface of the mixing tube 30 can be avoided.

More specifically, the second fuel F2 is injected from the inner wall surface 33 of the mixing tube 30 by the second fuel injection unit 70, so that the fuel concentration of the inner wall surface 33 can be increased. Therefore, the fuel concentration in the vicinity of the inner wall surface 33 is also increased near the outlet of the mixing tube 30, and the combustion speed at the outer edge portion of the outlet opening 32 of the mixing tube 30, which is the starting point of flame holding, can be increased. As a result, the flame can be continuously stabilized.

As described above, even in a case where each fuel having different reactivity is used, it is possible to perform stable combustion while suppressing flashback.

In a case where the combustor 3 is operated using the second fuel F2, a combustor nozzle for flame holding having a high fuel concentration may be separately provided in order to ensure flame holding performance. However, in this case, the temperature of the flame may locally rise, and the amount of NOx generated may increase.

By adopting the configuration of the present embodiment, it is possible to ensure the flame holding performance without providing the combustor nozzle separately, and thus it is possible to suppress the generation of NOx.

Here, in the present embodiment, a configuration is adopted in which the second fuel injection unit 70 is disposed in the mixing tube 30 on the upstream side and the first fuel injection unit 40 is disposed on the downstream side in the mixing tube 30. Accordingly, a flowing route from when the second fuel F2 is injected to when the second fuel F2 reaches the outlet opening 32 is sufficiently long. Therefore, the second fuel F2 can be sufficiently diffused and caused to pass through the entire region of the flow path cross section of the mixing tube 30. As a result, the fuel concentration in the vicinity of the inner wall surface 33 of the mixing tube 30 can be ensured, and stable flame holding can be performed by avoiding the occurrence of blow-out.

Meanwhile, a flowing route from when the first fuel F1 is injected from the first fuel injection unit 40 to when the first fuel F1 reaches the outlet of the mixing tube 30 is shortened. Therefore, since the straightness of the first fuel F1 can be ensured, it is possible to prevent the first fuel F1 from being diffused and reaching the inner wall surface 33 of the mixing tube 30. As a result, the occurrence of flashback can be suppressed.

Further, since the struts 50 have a wing shape, the air A in the mixing tube 30 can smoothly flow in the mixing tube 30. Therefore, an increase in pressure loss can be suppressed.

In addition, in the present embodiment, the second fuel injection unit 70 is provided in the strut 50 on the upstream side. Therefore, the jetted second fuel F2 also smoothly flows along the wing shape of the strut 50. Therefore, it is possible to suppress an increase in pressure loss due to the generation of an unintended vortex by the jet of the second fuel F2. In addition, it is possible to suppress a bias in fuel distribution such as a local increase in fuel concentration.

In addition, since a part of the mixing tube 30 is the reduced diameter wall surface 33b and the throttle flow path is formed, the flow speed can be increased in the mixing tube 30. In this manner, it is possible to avoid the occurrence of unintended flame holding due to inadvertent stagnation of the fuel in the mixing tube 30.

### Second Embodiment

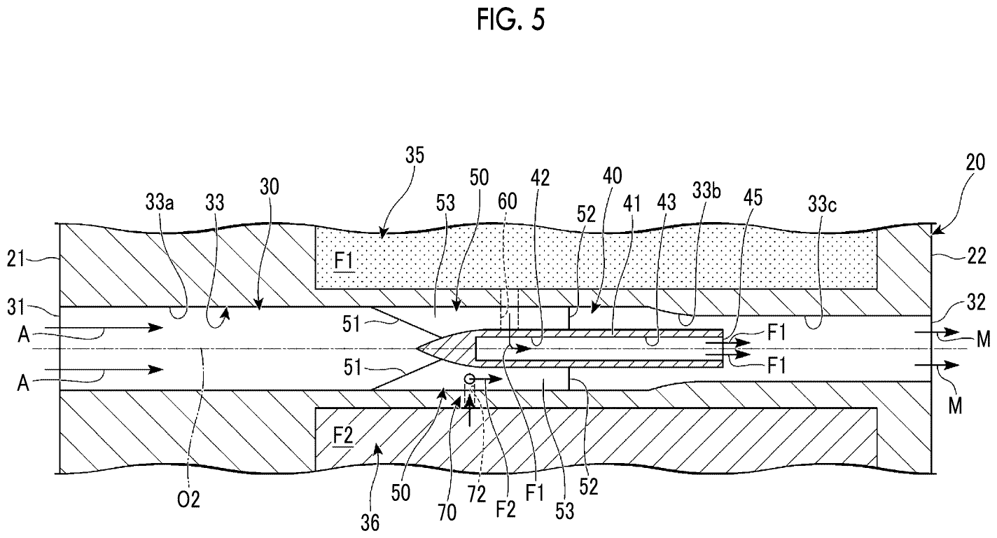

Next, a second embodiment of the present invention will be described with reference to FIG. 5. In the second embodiment, the same reference numerals will be assigned to configuration elements which are the same as those according to the first embodiment, and detailed description thereof will be omitted.

In the second embodiment, the configuration of the second fuel injection unit 70 is different from that of the first embodiment. That is, the second fuel injection unit 70 has a surface hole 72 that injects the second fuel F2 from the wing surface 53 that is the surface of the strut 50.

The surface hole 72 is open to the wing surface 53 of the strut 50 at the end portion of the mixing tube 30 on the radial inner side. An end portion of the surface hole 72 on the radial outer side is open to the second plenum 36. Accordingly, the surface hole 72 allows the inside of the mixing tube 30 and the second plenum 36 to communicate with each other via the wing surface 53 of the strut 50. The surface holes 72 may be formed in each of the pair of wing surfaces 53 of the strut 50, or may be formed in only one of the pair of wing surfaces 53. In addition, the surface holes 72 may be formed in each of the plurality of struts 50, or may be formed only in some of the struts 50.

With this configuration, as in the first embodiment, the second fuel F2 can be jetted into the mixing tube 30 at a position away from the central axis line O2 to the radial outer side. Therefore, the fuel concentration in the vicinity of the inner wall surface 33 of the mixing tube 30 can be increased as compared with a case where the second fuel F2 is jetted along the central axis line O2, and the flame holding performance can be ensured.

Further, the second fuel F2 is jetted into the flow of the air A flowing smoothly through the wing surface 53, so that it is possible to suppress the generation of an inadvertent vortex due to the jet of the second fuel F2. Therefore, an increase in pressure loss in the mixing tube 30 can be suppressed, and a bias in fuel distribution can be avoided.

Meanwhile, since the second fuel F2 can be appropriately mixed with the air A flowing through the wing surface 53, the mixing of the air A and the second fuel F2 can be promoted, and NOx can be reduced.

### Third Embodiment

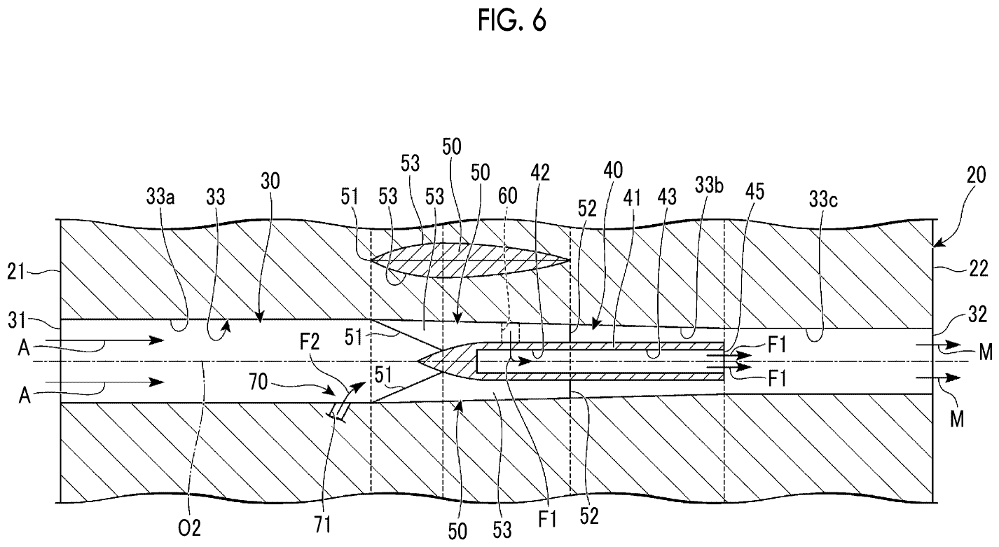

Next, a third embodiment of the present invention will be described with reference to FIG. 6. In the third embodiment, the same reference numerals will be assigned to configuration elements which are the same as those according to the first embodiment, and detailed description thereof will be omitted.

In the third embodiment, the shape of the mixing tube 30 is different from that of the first embodiment.

The reduced diameter wall surface 33b of the mixing tube 30 of the third embodiment is formed over a wider range than in the first embodiment. An end portion of the reduced diameter wall surface 33b on the upstream side is positioned in the same direction as the central axis line O2 as the end portion of the strut 50 on the upstream side. As in the first embodiment, the end portion of the reduced diameter wall surface 33b on the downstream side is positioned in the same direction as the central axis line O2 of the tip opening 45 of the fuel nozzle 41 of the first fuel injection unit 40. The reduced diameter wall surface 33b has a tapered shape that gradually reduces in diameter from the end portion on the upstream side to the end portion on the downstream side.

As described above, in the present embodiment, the reduced diameter wall surface 33b of the mixing tube 30 is provided at the forming position of the strut 50. Accordingly, the flow path cross-sectional area of the mixing tube 30 can be configured to be in accordance with the change in shape of the strut 50. Therefore, it is possible to avoid the occurrence of a low-speed region in the mixing tube 30, and it is possible to prevent the inadvertent occurrence of flame holding in the mixing tube 30.

### OTHER EMBODIMENTS

Although the embodiments of the present invention have been described hereinbefore, the present invention is not limited thereto and can undergo some changes as appropriate without departing from the technical scope of the invention.

For example, in the embodiment, an example in which hydrogen is used as the first fuel F1 and natural gas is used as the second fuel F2 has been described. However, the present disclosure is not limited thereto. Various types of fuels can be adopted as the first fuel F1 and the second fuel F2.

In addition, at least one of the first fuel F1 and the second fuel F2 may be used as a mixed fuel of hydrogen and natural gas. Also in this case, the first fuel F1 can be made more reactive than the second fuel F2 with the mixing ratio between the hydrogen and the natural gas. Therefore, by adopting the configuration of the present embodiment, it is possible to realize the configuration of the combustor 3 suitable for both the first fuel F1 and the second fuel F2. Further, by adjusting the fuel compositions of the first fuel F1 and the second fuel F2 in this way, it is possible to ensure flame holding performance while reducing the occurrence of flashback.

In the embodiment, the configuration is adopted in which the second fuel F2 is injected on the upstream side of the mixing tube 30 with respect to the first fuel F1. However, the present disclosure is not limited thereto. The first fuel F1 may be injected on the upstream side of the mixing tube 30 with respect to the second fuel F2, or the first fuel F1 and the second fuel F2 may be injected at the same position in the direction of the central axis line O2.

### Appendix

The combustor 3 and the gas turbine 1 described in each embodiment are understood, for example, as follows.
(1) The combustor 3 according to a first aspect is the combustor 3 including a combustor plate 20 that has a mixing tube 30 extending to penetrate an upstream end surface 21 and a downstream end surface 22 orthogonal to a combustor axis line O1 and into which air A is introduced from an upstream end surface 21 side; a first fuel injection unit 40 that is capable of injecting first fuel F1 along a central axis line O2 of the mixing tube 30 from inside the mixing tube 30; and a second fuel injection unit 70 that is capable of injecting second fuel F2 into the mixing tube 30 from a radial outer side of the central axis line O2 of the mixing tube 30.

Since the first fuel injection unit 40 injects the fuel along the central axis line O2 of the mixing tube 30, the increase in the fuel concentration on the wall surface of the mixing tube 30 of the first fuel F1 can be suppressed. Meanwhile, the second fuel F2 is injected from the second fuel injection unit 70 at a position away from the central axis line O2 of the mixing tube 30. Therefore, an extreme decrease in fuel concentration near the wall surface of the mixing tube 30 can be avoided.

Accordingly, it is possible to perform stable combustion while suppressing flashback.
(2) The combustor 3 according to a second aspect is the combustor 3 according to the first aspect, in which the first fuel injection unit 40 may inject the first fuel F1 from a downstream side in the mixing tube 30 with respect to the second fuel injection unit 70.

The second fuel F2 is injected by the second fuel injection unit 70 at a position away from the central axis line O2 of the mixing tube 30. In this manner, the second fuel F2 can be diffused and caused to pass through the entire region of the flow path cross section of the mixing tube 30. Since the first fuel injection unit 40 from which the first fuel F1 is injected along the central axis line O2 of the mixing tube 30 is positioned on the downstream side of the second fuel injection unit 70, a route from when the first fuel F1 is injected to when the first fuel F1 reaches the outlet of the mixing tube 30 is short. Therefore, it is possible to prevent the first fuel F1 from being diffused and reaching the inner wall surface 33 of the mixing tube 30.
(3) The combustor 3 according to a third aspect is the combustor 3 according to the first aspect or the second aspect, in which the second fuel injection unit 70 may have a wall surface hole 71 capable of injecting the second fuel F2 from the inner wall surface 33 of the mixing tube 30 into the mixing tube 30.

The second fuel F2 is injected from the inner wall surface 33 of the mixing tube 30 by the second fuel injection unit 70, so that the fuel concentration in the inner wall surface 33 at the outlet of the mixing tube 30 can be increased. Accordingly, the combustion speed at the starting point of the flame holding increases, and the flame can be stabilized.
(4) The combustor 3 according to a fourth aspect is the combustor 3 according to any one of the first aspect to the third aspect, in which the first fuel injection unit 40 may include a fuel nozzle 41 that extends in a direction of the central axis line O2 from inside the mixing tube 30 and in which a tip opening 45 for injecting the first fuel F1 to an end portion on a downstream side is formed, a strut 50 that extends in a radial direction of the central axis line O2 between the fuel nozzle 41 and an inner wall surface 33 of the mixing tube 30 and that connects the fuel nozzle 41 and the inner wall surface 33 of the mixing tube 30 to each other, and a fuel introduction portion 60 that introduces the first fuel F1 into the fuel nozzle 41 through an inside of the strut 50.

Accordingly, the first fuel injection unit 40 can appropriately inject the first fuel F1 along the central axis line O2 of the mixing tube 30.
(5) The combustor 3 according to a fifth aspect is the combustor 3 according to the fourth aspect, in which the strut 50 may have a wing shape with an end portion thereof on an upstream side set to a leading edge 51 and the end portion thereof on the downstream side set to a trailing edge 52.

Accordingly, the air A in the mixing tube 30 can smoothly flow, and an increase in pressure loss can be suppressed.
(6) The combustor 3 according to a sixth aspect is the combustor 3 according to the fourth aspect or the fifth aspect, in which the inner wall surface 33 of the mixing tube 30 may include an upstream wall surface 33a that is connected to the upstream end surface 21 and that extends toward the downstream side with a uniform inner diameter, a reduced diameter wall surface 33b that is connected to a downstream side of the upstream wall surface 33a and whose diameter is reduced toward the downstream side, and a downstream wall surface 33c that is connected to a downstream side of the reduced diameter wall surface 33b and extends toward the downstream end surface 22 with a uniform inner diameter smaller than an inner diameter of the upstream wall surface 33a.

Since a part of the mixing tube 30 is the reduced diameter wall surface 33b and the throttle flow path is formed, the flow speed can be increased in the mixing tube 30. In this manner, it is possible to avoid the occurrence of flame holding at an unintended location in the mixing tube 30.
(7) The combustor 3 according to a seventh aspect is the combustor 3 according to the sixth aspect, in which the reduced diameter wall surface 33b may extend from a position in a direction of a central axis line O2 of an end portion of the strut 50 on an upstream side to a position in a direction of a central axis line O2 of the tip opening 45.

By narrowing the flow path of the mixing tube 30 in accordance with the disposition position of the strut 50, it is possible to avoid the generation of the low-speed region in the mixing tube 30. In this manner, it is possible to further avoid unintended flame holding in the mixing tube 30.
(8) The combustor 3 according to an eighth aspect is the combustor 3 according to any one of the fourth aspect to the seventh aspect, in which the second fuel injection unit 70 may have a surface hole 72 capable of injecting the second fuel F2 from a surface of the strut 50 into the mixing tube 30.

Accordingly, the second fuel F2 can be injected at a position away from the central axis line O2 of the mixing tube 30. Therefore, the fuel concentration in the inner wall surface 33 at the outlet of the mixing tube 30 can be increased. Accordingly, the combustion speed at the starting point of the flame holding is increased, and the flame can be stabilized.
(9) The combustor 3 according to a ninth aspect is the combustor 3 according to any one of the first aspect to the eighth aspect, in which the first fuel F1 may be more reactive than the second fuel F2.

In a case where the easily reactive first fuel F1 is used, the first fuel F1 can be prevented from reaching the inner wall surface 33 of the mixing tube 30 by being injected along the central axis line O2 of the mixing tube 30. In this manner, the increase in the fuel concentration near the inner wall surface 33 of the mixing tube 30 can be suppressed, and the occurrence of flashback can be suppressed.

On the other hand, in a case where the second fuel F2 that is difficult to burn is used, the fuel can be injected from the inner wall surface 33 of the mixing tube 30 to increase the fuel concentration near the inner wall surface 33. Accordingly, the combustion speed at the starting point of the flame holding at the outlet of the mixing tube 30 is increased, and thus it is possible to stably perform the flame holding.
(10) The gas turbine 1 according to a tenth aspect includes a compressor 2 that generates air A; the combustor 3 according to any one of the first aspect to the ninth aspect that generates a combustion gas C by burning a premixed gas M generated by mixing fuel with the air A compressed by the compressor 2; and a turbine 4 driven by the combustion gas C.

### INDUSTRIAL APPLICABILITY

According to the present disclosure, it is possible to provide a combustor and a gas turbine capable of avoiding a blow-out while suppressing flashback.

### REFERENCE SIGNS LIST

1: gas turbine
2: compressor
3: combustor
4: turbine
10: outer cylinder
11: end cover
15: inner cylinder
17: support portion
20: combustor plate
21: upstream end surface
22: downstream end surface
30: mixing tube
31: inlet opening
32: outlet opening
33: inner wall surface
33a: upstream wall surface
33b: reduced diameter wall surface
33c: downstream wall surface
35: first plenum
36: second plenum
37: connection member
38: first fuel supply system
39: second fuel supply system
40: first fuel injection unit
41: fuel nozzle
42: cavity
45: tip opening
50: strut
51: leading edge
52: trailing edge
53: wing surface
60: fuel introduction portion
70: second fuel injection unit
71: wall surface hole
72: surface hole
A: air
M: premixed gas
C: combustion gas
O1: combustor axis line
O2: central axis line
F1: first fuel
F2: second fuel

1. A combustor comprising:
a combustor plate that has a mixing tube extending to penetrate an upstream end surface and a downstream end surface and into which air is introduced from an upstream end surface side;
a first fuel injection unit that is capable of injecting first fuel along a central axis line of the mixing tube from inside the mixing tube; and
a second fuel injection unit that is capable of injecting second fuel into the mixing tube from a radial outer side of the central axis line of the mixing tube.

2. The combustor according to claim 1, wherein
the first fuel injection unit injects the first fuel from a downstream side in the mixing tube with respect to the second fuel injection unit.

3. (canceled)

4. The combustor according to claim 1, wherein
the first fuel injection unit includes
a fuel nozzle that extends in a direction of the central axis line from inside the mixing tube and in which a tip opening for injecting the first fuel to an end portion on a downstream side is formed,
a strut that extends in a radial direction of the central axis line between the fuel nozzle and an inner wall surface of the mixing tube and that connects the fuel nozzle and the inner wall surface of the mixing tube to each other, and
a fuel introduction portion that introduces the first fuel into the fuel nozzle through an inside of the strut.

5. The combustor according to claim 4, wherein
the strut has a wing shape with an end portion thereof on an upstream side set as a leading edge and the end portion thereof on the downstream side set as a trailing edge.

6. The combustor according to claim 4, wherein
the inner wall surface of the mixing tube includes
an upstream wall surface that is connected to the upstream end surface and that extends toward the downstream side with a uniform inner diameter,
a reduced diameter wall surface that is connected to a downstream side of the upstream wall surface and whose diameter is reduced toward the downstream side, and
a downstream wall surface that is connected to a downstream side of the reduced diameter wall surface and extends toward the downstream end surface with a uniform inner diameter smaller than an inner diameter of the upstream wall surface.

7. The combustor according to claim 6, wherein
the reduced diameter wall surface extends from a position in a direction of a central axis line of an end portion of the strut on an upstream side to a position in a direction of a central axis line of the tip opening.

8. The combustor according to claim 4, wherein
the second fuel injection unit has a surface hole capable of injecting the second fuel into the mixing tube from a surface of the strut.

9. The combustor according to claim 1, wherein
the second fuel injection unit has a wall surface hole capable of injecting the second fuel into the mixing tube from an inner wall surface of the mixing tube.

10. The combustor according to claim 1,
wherein
the combustor plate includes a plurality of the mixing tubes; and
each of the mixing tubes includes the first fuel injection unit and the second fuel injection unit.

11. The combustor according to claim 1, wherein
the first fuel is more reactive than the second fuel.

12. A gas turbine comprising:
a compressor that generates air;
the combustor according to claim 1 that generates a combustion gas by burning a premixed gas generated by mixing fuel with the air compressed by the compressor; and
a turbine driven by the combustion gas.

13. The combustor according to claim 4, wherein
the second fuel injection unit has a wall surface hole capable of injecting the second fuel into the mixing tube from an inner wall surface of the mixing tube.

14. The combustor according to claim 4, wherein
the combustor plate includes a plurality of the mixing tubes, and
each of the mixing tubes includes the first fuel injection unit and the second fuel injection unit.

15. The combustor according to claim 4, wherein
the first fuel is more reactive than the second fuel.

16. The combustor according to claim 10, wherein
the first fuel is more reactive than the second fuel.

17. A gas turbine comprising:
a compressor that generates air;
the combustor according to claim 4 that generates a combustion gas by burning a premixed gas generated by mixing fuel with the air compressed by the compressor; and
a turbine driven by the combustion gas.

18. A gas turbine comprising:
a compressor that generates air;
the combustor according to claim 4 that generates a combustion gas by burning a premixed gas generated by mixing fuel with the air compressed by the compressor; and
a turbine driven by the combustion gas.
